(19) United States
(12) Patent Application Publication
(10) Pub. No.: US 2019/0031836 A1
(43) Pub. Date: Jan. 31, 2019

(54) Method For Producing A Masterbatch Comprising A Diene Elastomer, An Organic Reinforcing Filler And, Optionally, An Antioxidant

(71) Applicant: COMPAGNIE GENERALE DES ETABLISSEMENTS MICHELIN, Clermont-Ferrand (FR)

(72) Inventors: Charbel KANAAN, Clermont-Ferrand Cedex 9 (FR); Ron GROSZ, Andover, MA (US)

(21) Appl. No.: 16/062,524

(22) PCT Filed: Dec. 16, 2016
(86) PCT No.: PCT/FR2016/053491

§ 371 Date: Jun. 14, 2018

(30) Foreign Application Priority Data
Dec. 16, 2015 (FR) 1562512

(51) Int. Cl. C08J 3/22; C08J 3/20; C08K 3/04; C08K 5/18

(52) U.S. Cl. CPC C08J 3/226; C08J 3/203; C08J 2307/00; C08K 5/18; C08K 3/04

(57) ABSTRACT

Process for preparing a masterbatch, comprising a diene elastomer and a reinforcing filler, and having a dispersion of the reinforcing filler in the elastomer matrix that has a Z value greater than or equal to 80, the diene elastomer comprises at least natural rubber. The process comprises the following successive steps: a) introducing, in order to obtain a masterbatch in the form of dried mass, a coagulum into at least one continuous mixer, the coagulum comprises the diene elastomer and the reinforcing filler dispersed, with a Z value greater than or equal to 80, in the dried mass; b) passing the mass leaving the continuous mixer into a roll mill in order to obtain a masterbatch in strip form; then c) optionally, introducing the strip leaving the roll mill and an antioxidant into a continuous mixer so as to obtain a masterbatch comprising an antioxidant; and d) recovering, following step b) or c), the masterbatch having a moisture content of less than 1% by weight. The throughputs of steps a) and b) are greater than 500 kg/h. When an antioxidant is present in the masterbatch obtained at the end of step d), the whole of the antioxidant is introduced during step c).

The present invention aims to improve the industrial efficiency of processes for preparing masterbatches comprising a diene elastomer and a reinforcing organic filler finely dispersed in the elastomer matrix.

The term “masterbatch” is understood to mean: an elastomer-based composite into which a filler and optionally other additives have been introduced. Within the context of the present invention, the elastomer comprises natural rubber.

According to the invention, the masterbatch is particularly used for the manufacture of reinforced diene rubber compositions intended for the manufacture of tyres or of semi-finished products for tyres, in particular of treads of these tyres.

It is known that in order to obtain the optimum reinforcing properties and hysteresis properties imparted by a filler to a tyre tread, and thus to obtain high wear resistance and low rolling resistance, it is generally advisable for this filler to be present in the elastomer matrix in a final form that is both as finely divided as possible and as uniformly distributed as possible. However, such conditions can be achieved only if this filler has a very good capacity, on the one hand, to be incorporated into the matrix during the mixing with the elastomer and to deagglomerate, and, on the other hand, to disperse uniformly in this matrix.

There are various ways of obtaining a masterbatch of diene elastomer and of reinforcing filler. In particular, one type of solution consists, in order to improve the dispersibility of the filler in the elastomer matrix, in mixing the elastomer and the filler in the “liquid” phase. To do this, use is made of an elastomer in the form of latex which is in the form of elastomer particles dispersed in water, and of an aqueous dispersion of the filler, i.e. a filler dispersed in water, commonly referred to as a “slurry”. Certain processes in particular, such as those described in document US 6 048 923, make it possible to obtain a masterbatch of elastomer and filler that has a very good dispersion of the filler in the elastomer matrix, greatly improved compared to the dispersion of the filler in the elastomer matrix that may be obtained during the solid-phase mixing of elastomer and reinforcing filler. This process consists especially in feeding a continuous flow of a first fluid including an elastomer to the mixing zone of a coagulation reactor, in feeding a second continuous flow of a second fluid including an aqueous dispersion of filler under pressure in the mixing zone to form a mixture with the elastomer latex; the mixing of these two fluids being sufficiently energetic to make it possible to almost completely coagulate the elastomer latex with the filler before the outlet orifice of the coagulation reactor, and then in drying the coagulum obtained.

The coagulum is usually dried to produce a masterbatch by a continuous process comprising the following successive steps:
Dewatering, usually in an extruder. The dewatered product is usually referred to as a “pellet” to denote the coagulum granules. The content of volatile matter, essentially water, is usually from 10% to 20% by weight.
Drying, mixing and masticating in a continuous mixer, usually a Banbury mixer or a Unimix Continuous Mixer sold by Farrel Corporation (this mixer is also denoted under the abbreviation “FCM”). During this step the mixture is masticated and heated. It is during this step that the various optional additives are added, and in particular the antioxidant which is considered to be a necessary additive. The product recovered at the outlet is usually referred to as “chunk” to denote the mass recovered. This mass is usually at a temperature ranging from 140° C. to 200° C. The content of volatile matter, essentially water, is usually from 1% to 3% by weight. In the presence of natural rubber in the elastomer matrix, this mass has a very high Mooney viscosity (thus for carbon black contents of greater than 65 phr, the Mooney viscosity is beyond the measurement capabilities of the machines, i.e. greater than 200 MU; reference may be made to “overtorque”) and it is therefore very difficult to work at a throughput compatible with industrial-scale manufacture. Thus, in practice, for carbon black contents of greater than 65 phr, at the outlet of the mixer a portion of the mass is sent to roll mills (and thus the throughput is divided in two), the remainder is customarily discarded. The remainder may represent a significant amount, that may for example correspond to half of the production leaving the mixer.

1Mastication by passing a portion of the mass recovered at the outlet of the continuous mixer into roll mills. These roll mills are in contact with the ambient air. At the outlet of the roll mills, the strip usually has a temperature ranging from 110° C. to 160° C. and a content of volatile matter of less than 1% by weight. End of line, that may in particular comprise steps of granulation, compacting in the form of bales, etc.
Optionally storage.

Thus, the current processes are not economical due to a significant loss (for example almost half) of the production between the steps of continuous mixing and mastication due to the excessively high Mooney viscosity of the product when the elastomer matrix comprises natural rubber.

A photo of a production of a masterbatch during the passage thereof on roll mills, at a throughput of 375 kg/h, is given in FIG. 1. It is noted that the sheet is highly cracked and that the strip that is obtained is not homogeneous with tears on the edges and is difficult to work (it is observed that the strip has a tendency to twist).

Surprisingly, it has been observed that it was possible to increase the throughput of the mastication step, which may be identical to the throughput of the dewatering and mixing steps. In other words, it has been observed that it was possible to send the whole of the mass leaving the continuous mixer to the roll mill(s).

Fortuitously and unexpectedly, the inventors have in fact observed that when the antioxidant is omitted or when the whole of the antioxidant present in the masterbatch obtained at the end of the process is introduced, no longer into the continuous mixer but after the roll mills, then it is possible to increase the throughput of the mastication step, which may be identical to the throughput of the dewatering and compounding steps. Thus, the whole of the mass leaving the continuous mixer may be masticated during the production.

Thus, one subject of the invention is a process for preparing a masterbatch, comprising a diene elastomer and a reinforcing filler, and having a dispersion of the reinforcing filler in the elastomer matrix that has a Z value greater than or equal to 80, the diene elastomer comprises at least natural rubber, the process comprises the following successive steps:
a) introducing, in order to obtain a masterbatch in the form of dried mass, a coagulum into at least one continuous mixer, said coagulum comprises said diene elastomer and said reinforcing filler dispersed, with a Z value greater than or equal to 80, in the dried mass;
b) passing the mass leaving the continuous mixer into a roll mill in order to obtain a masterbatch in strip form; then
c) optionally, introducing the strip leaving the roll mill and an antioxidant into a continuous mixer so as to obtain a masterbatch comprising an antioxidant;
d) recovering, following step b) or c), said masterbatch having a moisture content of less than 1% by weight,
   characterized in that the throughputs of steps a) and b) are greater than 500 kg/h, and in that when an antioxidant is present in the masterbatch obtained at the end of step d), the whole of said antioxidant is introduced during step c).

Advantageously, the whole of the mass leaving the continuous mixer of step a) is sent to the roll mill of step b).

The masterbatch advantageously has a dispersion of the reinforcing filler in the elastomer matrix having a Z value greater than or equal to 90.

Prior to step a) the coagulum is advantageously obtained by liquid-phase mixing starting from a latex of the diene elastomer and an aqueous dispersion of the reinforcing filler. In particular, it is obtained according to the following steps:
feeding a continuous flow of the diene elastomer latex to a mixing region of a coagulation reactor defining an elongated coagulation region extending between the mixing region and an outlet,
feeding a continuous flow of a fluid comprising a reinforcing filler under pressure to the mixing region of a coagulation reactor in order to form a coagulated mixture,
dewatering the coagulum obtained previously in order to recover the dewatered coagulum of step a).

In a first variant, the masterbatch obtained at the end of step d) does not comprise antioxidant. In this variant, step c) is omitted and the masterbatch obtained at the end of step d) does not comprise antioxidant.

In a second variant, step c) is carried out, the masterbatch obtained at the end of step d) comprises an antioxidant and the whole of said antioxidant is introduced during step c).

The reinforcing filler is advantageously a carbon black. The content of carbon black is advantageously between 40 and 90 phr, preferably between 45 and 80 phr.

The diene elastomer is advantageously a natural rubber.

The antioxidant may be an N-alkyl-N′-phenyl-para-phenyldiamine corresponding to the formula (I):

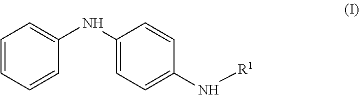

in which R¹ represents a linear or branched alkyl group having from 1 to 12 carbon atoms or a cycloalkyl group having from 5 to 8 carbon atoms.

Another subject of the invention is a process for preparing a rubber composition comprising the following steps:
(A) preparing a masterbatch, comprising a diene elastomer and a reinforcing filler by the process according to the invention;
(B) high-temperature thermomechanical kneading of the masterbatch obtained following step (A) with the other constituents of the rubber composition, except for the vulcanization system;
(C) mechanical working, at a temperature below the temperature of step (B), of the product resulting from step (B) and incorporation of the vulcanization system.

### I—MEASUREMENTS AND TESTS

The rubber compositions are characterized, before and after curing, as indicated below.

### Mooney Plasticity

Use is made of an oscillating consistometer as described in French Standard NF T 43-005 35 (1991). The Mooney plasticity measurement is carried out according to the following principle: the composition in the raw state (i.e., before curing) is moulded in a cylindrical chamber heated to 115° C. After preheating for 5 minutes, the (small-sized) rotor rotates within the test specimen at 0.04 rpm and the working torque for maintaining this movement is measured after rotating for 10 minutes. The Mooney plasticity MS (5+10) is expressed in “Mooney units” (MU, with 1 MU=0.83 newton.metre). When the viscosity is too high, the rotor does not manage to rotate and the torque cannot be measured.

### Dispersion

In a known manner, the dispersion of filler in an elastomer matrix may be represented by the Z value, which is measured, after crosslin king, according to the method described by S. Otto et al. in Kautschuk Gummi Kunststoffe, 58 Jahrgang, NR 7-8/2005, in agreement with Standard ISO 11345.

The calculation of the Z value is based on the percentage of surface area in which the filler is not dispersed (“% undispersed surface area”), as measured by the “disperGRADER+” device supplied, with its operating instructions and “disperDATA” operating software, by Dynisco, according to the equation:

Z=100−(% undispersed surface area)/0.35

The undispersed surface area percentage is, for its part, measured using a camera looking at the surface of the sample under incident light at 30°. The light points are associated with filler and agglomerates, whereas the dark points are associated with the rubber matrix; digital processing converts the image into a black and white image, and allows the percentage of undispersed surface area to be determined as described by S. Otto in the abovementioned document.

The higher the Z value, the better the dispersion of the filler in the elastomer matrix (a Z value of 100 corresponding to a perfect dispersion and a Z value of 0 to a mediocre dispersion). A Z value of greater than or equal to 80 will be deemed to correspond to a surface area having very good dispersion of the filler in the elastomer matrix.

### Tensile Tests

These tensile tests make it possible to determine the elasticity stresses and the properties at break. Unless otherwise indicated, they are carried out in accordance with French Standard NFT 46-002 of September 1988. At second elongation (i.e. after an accommodation cycle at the extension rate provided for the measurement itself) the nominal secant modulus (or apparent stress, in MPa) is measured at 100% elongation (denoted by MA100). The tensile measurements for determining the accommodated secant moduli are carried out at a temperature of 23° C.±2° C. and under standard hygrometry conditions (50±5% relative humidity).

### Tearability

The tearability indices are measured at 100° C. In particular, the force to be exerted in order to obtain the rupture (FRD, in MPa) is determined on a test specimen with dimensions of 10×105×2.5 mm that is notched in the centre of its length to a depth of 5 mm in order to give rise to the rupture of the test specimen.

### Dynamic Properties

The dynamic properties and in particular tan(δ)max, representative of the hysteresis, are measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to Standard ASTM D 1349-99, is recorded. A strain amplitude sweep is carried out from 0.1% to 100% peak-to-peak (outward cycle) and then from 100% to 0.1% peak-to-peak (return cycle). The results made use of are the complex dynamic shear modulus (G*) and the loss factor tan(δ). For the return cycle, the maximum value of tan(δ) observed, denoted tan(δ)max, is indicated.

### MFTR Fatigue: “MFTRA” Test:

The fatigue strength, expressed as number of cycles or in relative units (r.u.), is measured in a known manner on an unnotched test specimen subjected to repeated low-frequency tensile deformations up to an elongation of 20%, using a Monsanto (“MFTR” type) machine until the test specimen breaks, according to the French Standard NF T46-021.

### II. BRIEF DESCRIPTION OF THE FIGURES

FIG. 1 is a photograph of a masterbatch, not in accordance with the invention, during the passage thereof on roll mills.

FIG. 2 is a photograph of a masterbatch, in accordance with the invention, during the passage thereof on roll mills.

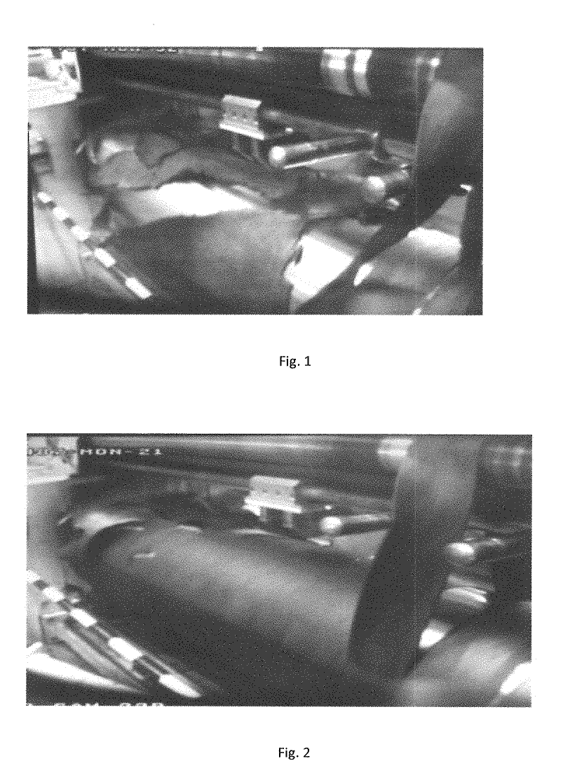

### III. DETAILED DESCRIPTION OF THE INVENTION

In the present description, unless expressly indicated otherwise, all the percentages (%) shown are % by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The expression “phr” signifies “parts by weight per hundred parts of elastomer”.

### III-1) Process for Preparing a Masterbatch

The process according to the invention comprises the following successive steps:
a) introducing, in order to obtain a masterbatch in the form of dried mass, a coagulum into at least one continuous mixer, said coagulum comprises said diene elastomer and said reinforcing filler dispersed with a Z value greater than or equal to 80;
b) passing the mass leaving the continuous mixer into a roll mill in order to obtain a masterbatch in strip form; then
c) optionally, introducing the strip leaving the roll mill and an antioxidant into a continuous mixer so as to obtain a masterbatch comprising an antioxidant;
d) recovering, following step b) or c), said masterbatch having a moisture content of less than 1% by weight,
   characterized in that the throughputs of steps a) and b) are greater than 500 kg/h, and in that when an antioxidant is present in the masterbatch obtained at the end of step d), the whole of said antioxidant is introduced during step c).

The process according to the invention makes it possible, during step b), for the whole of the mass leaving the continuous mixer to be sent to said roll mill. Thus, relative to the processes of the prior art, significant savings are possible.

The throughputs of steps a) and b) are greater than 500 kg/h, advantageously greater than 600 kg/h, for example ranging from 600 kg/h to 1300 kg/h. Since the process is a continuous process and the whole of the mass leaving the continuous mixer is sent to the roll mill of step b), the throughputs of steps a) and b) are advantageously identical. The expression “identical throughputs” is understood, for the purposes of the present invention, to mean throughputs that do not exceed 10% of losses.

In step a), the coagulum advantageously has a dispersion of the reinforcing filler in the elastomer matrix having a Z value greater than or equal to 90. The masterbatch obtained at the end of the process retains this very good dispersion. This step a) enables the drying, mixing with the optional additives introduced in the mixer, and mastication in order to obtain a masterbatch in the form of dried mass. The additives optionally added do not comprise antioxidant.

Prior to step a) the coagulum is advantageously obtained by liquid-phase mixing starting from a latex of the diene elastomer and an aqueous dispersion of the reinforcing filler.

In particular, the coagulum is obtained according to the following steps:
feeding a continuous flow of the diene elastomer latex to a mixing region of a coagulation reactor defining an elongated coagulation region extending between the mixing region and an outlet,
feeding a continuous flow of a fluid comprising a reinforcing filler under pressure to the mixing region of a coagulation reactor in order to form a coagulated mixture,
dewatering the coagulum obtained previously in order to recover the dewatered coagulum of step a).

The coagulum introduced during step a) is advantageously in the form of granules.

The coagulum introduced during step a) has advantageously been dewatered to a content of volatile matter ranging from 8% to 20% by weight, usually around 15% by weight. The volatile matter is essentially water.

The coagulum is advantageously introduced during step a) at a throughput of greater than 500 kg/h, more advantageously greater than 600 kg/h, even more advantageously ranging from 600 kg/h to 1300 kg/h.

During step a) the continuous mixer is advantageously an FCM. Conventionally, on leaving the continuous mixer of step a), or the last continuous mixer when several mixers are used, the mass is at a temperature between 140° C. and 200° C.

On leaving the continuous mixer of step a), or the last continuous mixer when several mixers are used, the mass advantageously has a content of volatile matter of less than 5% by weight.

Often, as soon as the content of reinforcing filler is 65 phr or more, on leaving the continuous mixer of step a), or the last continuous mixer when several mixers are used, the mass has a Mooney viscosity greater than 200 MU for a content of black of greater than or equal to 65 phr. That is to say that the mass has a Mooney viscosity so high that it cannot be measured.

Step b) enables a mastication of the dried mass obtained following step a).

The throughput of step b) is advantageously greater than 500 kg/h, more advantageously greater than 600 kg/h, even more advantageously ranging from 600 kg/h to 1300 kg/h.

During step b), the whole of the mass leaving the continuous mixer of step a), or the last continuous mixer when several mixers are used, is sent to the roll mill(s).

Following the mastication, a strip is recovered.

This strip, on leaving step b), is advantageously at a temperature between 110° C. and 160° C.

This strip, on leaving step b), advantageously has a content of volatile matter of less than 1% by weight, generally of from 0.3% to 0.5% by weight.

The throughput of step b) is advantageously greater than 500 kg/h, more advantageously greater than 600 kg/h, even more advantageously ranging from 600 kg/h to 1300 kg/h.

Following these steps, the strip, on leaving the roll mill, may be introduced into a continuous mixer in order to add an antioxidant thereto. When the masterbatch obtained at the end of the process comprises an antioxidant, it is during this step only that the whole of said antioxidant will be added. Any type of continuous mixer can be used, extruders being very suitable for example.

When no antioxidant is added, the strip, on leaving the roll mill, may be sent directly to the end of the line.

In one variant, step c) is omitted and the masterbatch obtained at the end of step d) does not comprise antioxidant. In this variant, the strip recovered at the end of step b) may be sent directly to the end of the line, that is to say to step d).

In this variant, the process according to the invention comprises the following steps:
a) introducing, in order to obtain a masterbatch in the form of dried mass, a coagulum into at least one continuous mixer, said coagulum comprises said diene elastomer and said reinforcing filler dispersed with a Z value greater than or equal to 80;
b) passing the mass leaving the continuous mixer into a roll mill in order to obtain a masterbatch in strip form; then
d) recovering, following step b), said masterbatch having a moisture content of less than 1% by weight,
   characterized in that the throughputs of steps a) and b) are greater than 500 kg/h, and in that the masterbatch obtained at the end of step d) does not comprise antioxidant.

In another variant, step c) is carried out, the masterbatch obtained at the end of step d) comprises an antioxidant and the whole of said antioxidant is introduced during step c).

Other additives may be added. They are preferentially added during step a) but they may also be added during step c) or another step of introducing the strip leaving the roll mill into a continuous mixer when no antioxidant is introduced in this process. As examples of these other additives, mention may for example be made of fillers (which may be identical to or different from the fillers already present in the coagulum; as an example of a filler, mention may be made of zinc oxide), other diene elastomers that correspond to the definitions given below, another masterbatch or an additional masterbatch on condition that they do not contain antioxidant if they are added during step a), plasticizers, processing aids (for example stearic acid, liquid polymers, oil, hydrocarbon-based waxes), resins, flame retardants, extender oils, lubricants, stabilizers (such as hydroxylamine sulfate), and mixtures thereof.

A photo of a production of a masterbatch according to the invention during the passage thereof on the rolls of the roll mill, at a throughput of 700 kg/h, is given in FIG. 2. It is noted that the sheet is torn very little and that the strip obtained is homogeneous (no tearing on the edges) and easy to work (absence of twists).

By the process according to the invention, it is possible to lower the Mooney viscosity of the mixture without degrading the properties thereof. This makes it possible to significantly improve the processability of the mixture on the rolls of the roll mill and therefore to increase the throughput over this (these) roll mill(s).

### III-2) Diene Elastomer

As is customary, the terms “elastomer” and “rubber”, which are interchangeable, are used without distinction in the text.

A “diene” elastomer or rubber should be understood, in a known way, as meaning an elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”. “Essentially unsaturated” is understood to mean generally a diene elastomer resulting at least in part from conjugated diene monomers having a content of units of diene origin (conjugated dienes) which is greater than 15% (mol %); thus, diene elastomers such as butyl rubbers or copolymers of dienes and of a-olefins of EPDM 20 type do not fall under the preceding definition and may especially be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

Among these diene elastomers, a distinction is furthermore made between natural rubber and synthetic elastomers.

In the expression “synthetic diene elastomers capable of being used in accordance with the invention”, the term “diene elastomer” is intended more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.
   The following are especially suitable as conjugated dienes: 1,3-butadiene, 2-methyl-1,3-butadiene, alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, pa ra-(tert-butyl)styrene, methoxystyrenes, chlorostyrenes, vinylmesitylene, divinylbenzene or vinylnaphthalene.

The copolymers may contain between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. For coupling with carbon black, mention may be made, for example, of functional groups comprising a C-Sn bond or amino functional groups, such as aminobenzophenone, for example; for coupling to an inorganic filler such as silica, mention may for example be made of silanol functional groups or polysiloxane functional groups having a silanol end (such as described, for example, in FR 2 740 778 or U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973, WO 2009/000750 and WO 2009/000752). Mention may also be made, as other examples of functionalized elastomers, of elastomers (such as SBR, BR, NR or IR) of the epoxidized type.

The following are suitable: polybutadienes and in particular those having a content (mol %) of 1,2-units of between 4% and 80% or those having a content (mol %) of cis-1,4-units of greater than 80%, polyisoprenes, butadiene/styrene copolymers and in particular those having a glass transition temperature Tg (Tg, measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers and especially those having an isoprene content of between 5% and 90% by weight and a Tg of −40° C. to −80° C., or isoprene/styrene copolymers and especially those having a styrene content of between 5% and 50% by weight and a Tg of between −5° C. and −50° C. In the case of butadiene/styrene/isoprene copolymers, those having a styrene content of between 5% and 50% by weight and more particularly of between 10% and 40%, an isoprene content of between 15% and 60% by weight and more 10 particularly of between 20% and 50%, a butadiene content of between 5% and 50% by weight and more particularly between 20% and 40%, a content (mol %) of 1,2-units of the butadiene part of between 4% and 85%, a content (mol %) of trans-1,4-units of the butadiene part of between 6% and 80%, a content (mol %) of 1,2- plus 3,4-units of the isoprene part of between 5% and 70% and a content (mol %) of trans-1,4-units of the isoprene part of between 10% and 50%, and more generally any butadiene/styrene/isoprene copolymer having a Tg of between −5° C. and −70° C., are especially suitable.

To summarize, the synthetic diene elastomer or elastomers according to the invention are preferentially selected from the group of highly unsaturated diene elastomers formed by polybutadienes (abbreviated to BRs), synthetic polyisoprenes (IRs), butadiene copolymers, isoprene copolymers and the mixtures of these elastomers. Such copolymers are more preferentially selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

As was specified above, liquid-phase mixing processes are preferentially used to make it possible to obtain masterbatches based on diene elastomer and on reinforcing filler that have a very good dispersion of the reinforcing filler in the elastomer. Thus, in particular for the preparation of the masterbatch of diene elastomer and reinforcing filler, use will more particularly be made of a diene elastomer latex, the elastomer latex being a particular form of the elastomer which exists in the form of water-dispersed elastomer particles. The invention thus preferentially relates to latices of diene elastomers, the diene elastomers being those defined previously.

More particularly, for natural rubber (NR), which forms all or some of the elastomer according to the invention, this natural rubber exists in various forms, as explained in detail in Chapter 3, “Latex concentrates: properties and composition”, by K. F. Gaseley, A. D. T. Gordon and T. D. Pendle in “Natural Rubber Science and Technology”, A. D. Roberts, Oxford University Press—1988. In particular, several forms of natural rubber latex are sold: the natural rubber latices referred to as “field latices”, the natural rubber latices referred to as “concentrated natural rubber latices”, epoxidized latices (ENRs), deproteinized latices or else prevulcanized latices. Natural rubber field latex is a latex to which ammonia has been added in order to prevent premature coagulation and concentrated natural rubber latex corresponds to a field latex which has undergone a treatment corresponding to a washing, followed by a further concentration. The various categories of concentrated natural rubber latices are listed in particular according to standard ASTM D 1076-06. Singled out in particular among these concentrated natural rubber latices are the concentrated natural rubber latices of the grade referred to as: “HA” (high ammonia) and of the grade referred to as “LA”; for the invention, use will advantageously be made of concentrated natural rubber latices of HA grade. The NR latex can be physically or chemically modified beforehand (centrifugation, enzymatic treatment, chemical modifier, etc.). The latex can be used directly or be diluted beforehand in water to facilitate the use thereof.

It should be noted that it is possible to envisage using one or more natural rubber latices as a blend, or a blend of one or more natural rubber latices with one or more synthetic rubber latices.

Thus, as synthetic elastomer latex, the latex can in particular consist of a synthetic diene elastomer already available in the form of an emulsion (for example, a butadiene/styrene copolymer, SBR, prepared in emulsion) or consist of a synthetic diene elastomer initially in solution (for example, an SBR prepared in solution) which is emulsified in a mixture of organic solvent and water, generally by means of a surfactant.

A latex of SBR, especially an SBR prepared in emulsion (“ESBR”) or an SBR prepared in solution (“SSBR”), and more particularly an SBR prepared in emulsion, is particularly suitable for the invention. There are two main types of processes for the emulsion copolymerization of styrene and butadiene, one of them, or hot process (carried out at a temperature close to 50° C.), being suitable for the preparation of highly branched SBRs, whereas the other, or cold process (carried out at a temperature which can range from 15° C. to 40° C.), makes it possible to obtain more linear SBRs. For a detailed description of the effectiveness of several emulsifiers which can be used in said hot process (as a function of the contents of said emulsifiers), reference may be made, for example, to the two papers by C. W. Carr, I. M. Kolthoff, E. J. Meehan, University of Minnesota, Minneapolis, Minn. which appeared in the Journal of Polymer Science of 1950, Vol. V, no. 2, pp. 201-206, and of 1951, Vol. VI, no. 1, pp. 73-81. Regarding comparative exemplary embodiments of said cold process, reference may be made, for example, to the paper in ½ Industrial and Engineering Chemistry, 1948, Vol. 5 40, no. 5, pp. 932-937, E. J. Vandenberg, G. E. Hulse, Hercules Powder Company, Wilmington, Del. + and to the paper in ½ Industrial and Engineering Chemistry, 1954, Vol. 46, no. 5, pp. 1065-1073, J. R. Miller, H. E. Diem, B. F. Goodrich Chemical Co., Akron, Ohio.

In the case of an SBR (ESBR or SSBR) elastomer, use is made in particular of an SBR having a moderate styrene content, for example of between 20% and 35% by weight, or a high styrene content, for example from 35% to 45%, a content of vinyl bonds of the butadiene part of between 15% and 70%, a content (mol %) of trans-1,4-bonds of between 15% and 75% and a Tg of between −10° C. and −55° C.; such an SBR can advantageously be used as a mixture with a BR preferably having more than 90% (mol %) of cis-1,4-bonds.

### III-3) Reinforcing Filler

The reinforcing filler is advantageously a reinforcing organic filler, a reinforcing inorganic filler or a reinforcing organic filler-reinforcing inorganic filler blend.

The reinforcing filler advantageously comprises a reinforcing organic filler.

All carbon blacks are suitable as reinforcing organic filler. All carbon blacks, especially blacks of the HAF, ISAF or SAF type, conventionally used in tyres (“tyre-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N400, N660, N683, N772 or N990). Also suitable as carbon black are the carbon blacks partially or completely covered with silica via a post-treatment, or the carbon blacks modified in situ by silica such as, non-limitingly, the fillers sold by the company Cabot Corporation under the name Ecoblack™ “CRX 2000” or “CRX4000”.

In a preferred variant, the reinforcing filler is a reinforcing organic filler.

It could also be envisaged to use, as reinforcing filler, a reinforcing inorganic filler. This reinforcing inorganic filler could be used alone or as a blend with the reinforcing organic filler.

The term “inorganic filler” should be understood here to mean, in a known way, any inorganic or mineral filler, irrespective of its colour and its origin (natural or synthetic), also known as “white filler”, “clear filler” or also “non-black filler”, in contrast to carbon black, this inorganic filler being capable of reinforcing, by itself, without means other than an optional intermediate coupling agent, a rubber composition intended for the manufacture of a tyre tread, in other words capable of replacing, in its reinforcing role, a conventional tyre-grade carbon black for a tread. Such a filler is generally characterized by the presence of functional groups, especially hydroxyl (—OH) functional groups, at its surface, that may require, in order to be used as reinforcing filler, the use of a coupling agent or system intended to provide a stable chemical bond between the isoprene elastomer and said filler. Such an inorganic filler may thus be used alone or with a coupling agent in order to enable the reinforcement of the rubber composition in which it is included. The physical state in which the inorganic filler is provided is not important, whether it is in the form of a powder, micropearls, granules, beads or any other appropriate densified form. Of course, the term “inorganic filler” is also understood to mean mixtures of various inorganic fillers, in particular of highly dispersible siliceous and/or aluminous fillers, as described below. Inorganic fillers of the siliceous type, in particular silica (SiO₂), or of the aluminous type, in particular alumina (Al₂O₃), are suitable in particular as inorganic fillers. The silica used can be any silica known to those skilled in the art, especially any precipitated or fumed silica having a BET surface area and a CTAB specific surface area both of less than 450 m²/g, preferably from 30 to 400 m²/g. Mention will be made, as highly dispersible precipitated silicas (“HDSs”), for example, of the Ultrasil 7000 and Ultrasil 7005 silicas from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/016387.

When the compositions of the invention are intended for tyre treads having a low rolling resistance, the inorganic filler used, in particular if it is silica, preferably has a BET surface area of between 45 and 400 m²/g, more preferentially of between 60 and 300 m²/g. Preferentially, the inorganic fillers for which the mean size (by weight) is between 20 and 300 nm, more preferentially between 20 and 150 nm, are particularly suitable for the present invention. This mean size is conventionally measured after dispersion, by ultrasonic deagglomeration, of the filler to be analysed in water or an aqueous solution containing a surfactant. For an inorganic filler, such as silica, the measurement is carried out using an X-ray detection centrifugal sedimentometer of XDC (X-ray Disc Centrifuge) type, sold by Brookhaven Instruments, according to the procedure which follows. A suspension of 3.2 g of sample of inorganic filler to be analysed in 40 ml of water is produced by the action over 8 minutes, at 60% power (60% of the maximum position of the “output control”), of a 1500 W ultrasonic probe (¾ inch Vibracell sonicator 10 sold by Bioblock); after sonication, 15 ml of the suspension are introduced into the disc rotating at a speed that varies between 3000 and 6000 rpm (the speed being adapted as a function of the mean size of the filler: the smaller the size, the higher the speed); after sedimentation for 120 minutes, the distribution by weight of the particle sizes and the mean size by weight of the particles dw are calculated by the software of the XDC sedimentometer (dw=Σ(ni di5)/Σ(ni di4) with ni being the number of objects of the size or diameter class di).

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes. Use is made in particular of silane polysulfides, referred to as “symmetrical” or “asymmetrical” depending on their specific structure, such as described, for example, in Applications WO 03/002648 (or US 2005/016651) and WO 03/002649 (or US 2005/016650).

Preferentially, the content of total filler (carbon black and/or inorganic filler such as silica) is between 40 and 200 phr, and more preferentially between 40 and 150 phr and more preferentially still between 40 and 100 phr, the optimum being, in a known way, different according to the specific applications targeted: the expected level of reinforcement with regard to a bicycle tyre, for example, is, of course, lower than that required with regard to a tyre capable of running at high speed in a sustained manner, for example a motorcycle tyre, a tyre for a passenger vehicle or a tyre for a utility vehicle, such as a heavy-duty vehicle.

According to one embodiment of the invention, the reinforcing filler is carbon black. Use is advantageously made of carbon black, the content of which varies from 40 to 90 phr, advantageously from 45 to 80 phr.

According to another embodiment of the invention, the reinforcing filler is a blend of carbon black and silica. Use is advantageously made of carbon black, the content of which varies from 35 to 80 phr, and an inorganic filler, in particular silica, the content of which varies from 5 to 50 phr, more particularly the total filler of the composition comprises carbon black, the content of which varies from 35 to 70 phr and an inorganic filler, in particular silica, the content of which varies from 5 to 35 phr, more preferentially still the total filler comprises carbon black, the content of which varies from 40 to 65 phr and an inorganic filler, in particular silica, the content of which varies from 10 to 30 phr.

Advantageously, the masterbatch does not comprise coupling agent, even in the presence of an inorganic reinforcing filler.

Advantageously, the masterbatches and the compositions thus produced are capable of being used in tyre applications. The rubber compositions for tyres based on masterbatches and on reinforcing filler according to the invention can also comprise, in a known way, a covering agent and where appropriate a coupling agent.

### III-4) Antioxidant

In a first variant, the masterbatch obtained at the end of step d) does not comprise antioxidant.

In a second variant, the masterbatch obtained at the end of step d) comprises an antioxidant and the whole of said antioxidant is introduced during step c).

In this second variant, it is possible to use, as antioxidant, one or more antioxidants. The antioxidant may be of the following type: amine, phenol, imidazole, metal carbamate salt, para-phenylenediamine(s) and/or dihydrotrimethylquinoline(s), polymerized quinine, wax or any other antioxidant normally used in elastomer formulations. As specific examples, mention may be made of: N-(1,3-dimethylbutyl)-N′-phenyl-p-phenylenediamine (6-PPD, sold for example under the brands ANTIGENE® 6C by Sumitomo Chemical Co., Ltd. and NOCLAC® 6C by Ouchi Shinko Chemical Industrial Co., Ltd.), the product “Ozonon” 6C sold by Seiko Chemical Co., Ltd., polymerized 1,2-dihydro-2,2,4-trimethylquinoline (TMQ, sold for example under the brand Agerite Resin D, by R. T. Vanderbilt), butylhydroxytoluene (BHT), and butylhydroxyanisole (BHA).

The antioxidant is advantageously an N-alkyl-N′-phenyl-para-phenyldiamine corresponding to the formula (I):

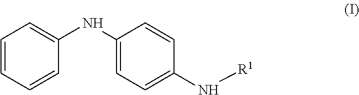

in which R¹ represents a linear or branched alkyl group having from 1 to 12 carbon atoms or a cycloalkyl group having from 5 to 8 carbon atoms.

Preferably, R¹ represents an alkyl having from 2 to 8 carbon atoms, preferentially selected from the group consisting of ethyl, propyl (i.e., n-propyl, isopropyl), butyl (i.e., n-butyl, sec-butyl and tert-butyl), pentyl, hexyl, heptyl and octyl, or a cycloalkyl group having from 5 to 8 carbon atoms (cyclopentyl, cyclohexyl, cycloheptyl, cyclooctyl), more preferentially a cyclohexyl group.

Use is more preferentially made of compounds for which the R¹ groups are branched, of formula (I-bis) below:

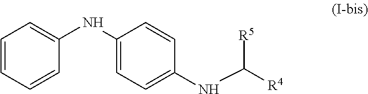

in which R⁴, R⁵, which are identical to or different from one another, each represent an alkyl group, the number of carbon atoms of which is in accordance with the preferential definitions given above for R¹.

As more preferred examples of branched R¹ radicals, mention will in particular be made of isopropyl, 1,3-dimethylbutyl and 1,4-dimethylpentyl.

The compounds of formula (I-a) above are well known to a person skilled in the art. They have been used for a very long time as anti-ageing protection agents in rubber compositions for tyres, in particular in the belts of such tyres, and belong to the family of para-phenylenediamine (“PPD”) derivatives such as for example N-isopropyl-N′-phenyl-para-phenylenediamine (“I-PPD”)

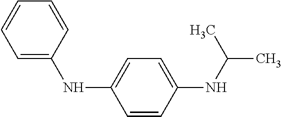 [SMILES: CC(C)Nc1ccc(Nc2ccccc2)cc1]

or N-1,3-dimethylbutyl-N′-phenyl-para-phenylenediamine (“6-PPD”)

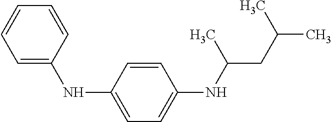 [SMILES: CC(C)CC(C)Nc1ccc(Nc2ccccc2)cc1]

which are simultaneously excellent antioxidants and antiozonants (see for example applications WO 2004/033548, WO 2005/063510).

In this second variant, the antioxidants are usually introduced in an amount ranging from 0.5 phr to 5 phr.

### III-5) Other Additives

These rubber compositions in accordance with the invention may also comprise all or some of the standard additives customarily used in elastomer compositions intended for the manufacture of tyres, in particular treads, such as for example plasticizers or extender oils, whether the latter are of aromatic or non-aromatic type, pigments, protection agents such as antiozone waxes, chemical antiozonants, anti-fatigue agents, reinforcing resins, methylene acceptors (for example, phenol-novolac resin) or methylene donors (for example, HMT or H3M) as described, for example, in application WO 02/10269, a crosslinking system based on either sulfur or on sulfur donors, and/or on peroxide and/or on bismaleimides, and vulcanization accelerators.

Preferably, these compositions comprise, as preferential non-aromatic or very weakly aromatic plasticizing agent, at least one compound selected from the group consisting of naphthenic oils, paraffinic oils, MES oils, TDAE oils, glycerol esters (in particular trioleates), plasticizing hydrocarbon resins having a high Tg preferably above 30° C., and the mixtures of such compounds. It should be noted that it is also possible to envisage producing the masterbatches in accordance with the invention by incorporating therein, in particular before the drying phase of the production of the masterbatch in the liquid phase, additives such as described above, oil, antioxidant, coupling agent, covering agent, etc.

### III-6) Manufacture of the Rubber Compositions:

Another subject of the invention is a process for preparing a rubber composition comprising the following steps:
A) preparing a masterbatch, comprising a diene elastomer and a reinforcing filler by the process according to the invention;
B) high-temperature thermomechanical kneading of the masterbatch obtained following step A) with the other constituents of the rubber composition, except for the vulcanization system;
C) mechanical working, at a temperature below the temperature of step B), of the product resulting from step B) and incorporation of the vulcanization system.

The rubber compositions of the invention are manufactured in appropriate mixers, using two successive phases of preparation (steps B) and C)) according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

According to one embodiment of the invention, all the base constituents of the compositions of the invention, with the exception of the vulcanization system, are incorporated intimately, by kneading, during said non-productive first phase, that is to say at least these various base constituents are introduced into the mixer and thermomechanically kneaded, in one or more steps, until the maximum temperature of between 130° C. and 200° C., preferably between 145° C. and 185° C., is reached.

According to a preferred embodiment of the invention, the base constituents of the compositions of the invention, with the exception of the vulcanization system, are incorporated in the diene elastomer and in the reinforcing filler, which have been prepared beforehand in the form of a first masterbatch. When the masterbatch does not comprise antioxidant, such an antioxidant is added during this step B).

This first masterbatch is produced in the “liquid” phase. To do this, use was made of the diene elastomer in the form of a latex, which exists in the form of elastomer particles dispersed in water, and of an aqueous dispersion of the carbon black, i.e. a filler dispersed in water, commonly known as a “slurry”. More preferentially still, the steps of the process described in document U.S. Pat. No. 6,048,923 will be followed, which process consists in particular in feeding a continuous flow of a first fluid including the elastomer latex in the mixing region of a coagulation reactor, in feeding a second continuous flow of a second fluid including the aqueous dispersion of carbon black under pressure in the mixing region in order to form a mixture with the elastomer latex; the mixing of these two fluids being sufficiently energetic to make it possible to almost completely coagulate the elastomer latex with the carbon black before the outlet orifice of the coagulation reactor, and then in drying the coagulum obtained according to the process of the invention.

According to another preferred embodiment of the invention, an inorganic filler and a second elastomer are incorporated into the first masterbatch by also being provided in the form of a second masterbatch which will have been prepared beforehand. This second masterbatch may be prepared in particular in the solid form by thermomechanically kneading the second elastomer and the inorganic filler; it may also be prepared by any other process and in particular it may also be prepared in the liquid phase.

It should in particular be noted that, in the case of the incorporation of a second elastomer and/or of an inorganic filler, this or these incorporations can be carried out simultaneously with the introduction into the mixer of the other constituents (in particular the first diene elastomer or first masterbatch) but also advantageously that this or these incorporations can be offset in time from a few tens of seconds to a few minutes.

It should be noted that, in the case of an addition of an inorganic filler and a second elastomer, these can be introduced separately or in the form of a second masterbatch comprising the second elastomer and the inorganic filler. In the case of introduction of the second elastomer alone and the inorganic filler alone, offset in time from a few tens of seconds to a few minutes, the inorganic filler can be introduced before, after or simultaneously with the second elastomer.

By way of example, the (non-productive) first phase is performed in a single thermomechanical step during which all the necessary constituents (where appropriate in the form of masterbatches as specified above), the optional additional covering agents or processing aids and various other additives, in particular the antioxidant when the masterbatch does not comprise any, with the exception of the vulcanization system, are introduced into an appropriate mixer, such as a standard internal mixer. The total duration of the kneading, in this non-productive phase, is preferably between 1 and 15 min. After cooling the mixture thus obtained during the non-productive first phase, the vulcanization system is then incorporated at low temperature, generally in an external mixer, such as an open mill; everything is then mixed (productive phase) for a few minutes, for example between 2 and 15 min.

The crosslinking system is preferentially a vulcanization system, i.e. a system based on sulfur (or on a sulfur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), are added to this base vulcanization system, being incorporated during the non-productive first phase and/or during the productive phase, as described subsequently.

The sulfur is used at a preferred content of between 0.5 phr and 12 phr, in particular between 1 phr and 10 phr. The primary vulcanization accelerator is used at a preferred content of between 0.5 phr and 10 phr, more preferentially of between 0.5 phr and 5.0 phr.

Use may be made, as (primary or secondary) accelerator, of any compound capable of acting as accelerator for the vulcanization of diene elastomers in the presence of sulfur, especially accelerators of thiazole type, and also their derivatives, and accelerators of thiuram and zinc dithiocarbamate types. These accelerators are, for example, selected from the group consisting of 2-mercaptobenzothiazole disulfide (abbreviated to “MBTS”), tetrabenzylthiuram disulfide (“TBZTD”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), zinc dibenzyldithiocarbamate (“ZBEC”) and the mixtures of these compounds.

The final composition thus obtained is subsequently calendered, for example in the form of a sheet or of a slab, in particular for laboratory characterization, or else extruded in the form of a rubber profiled element which can be used, for example, as a tyre tread for a passenger vehicle, heavy duty vehicle, etc.

It should be noted that such a composition can advantageously constitute the whole of the tread. However, the invention also applies to the cases where these rubber compositions form a portion only of a composite tread consisting, for example, of two radially superimposed layers of different formulations (“cap-base” structure), both intended to come into contact with the road when the tyre is rolling, during the life of the latter. The portion based on compositions in accordance with the invention can then constitute the radially outer layer of the tread intended to come into contact with the ground from the moment when the new tyre starts rolling or, on the other hand, its radially inner layer intended to come into contact with the ground at a later stage.

### IV EXEMPLARY EMBODIMENTS OF THE INVENTION

Mooney plasticity is expressed in Mooney units (MU, with 1 MU=0.83 Newton.meter).

### EXAMPLE 1

### IV-1.1 Preparation of a Masterbatch of Natural Rubber and Carbon Black

Coagulums of natural rubber (100 phr) and of carbon black (72 phr) having a very good dispersion value of the filler in the elastomer matrix are produced in the liquid phase according to the process described in U.S. Pat. No. 6,048,923.

They are then dried according to the following processes:

Masterbatch M1 (Not in Accordance with the Invention):

At the outlet of the dewaterer, pellets having a throughput of 700 kg/h of dry product and loaded with 15% volatile matter (essentially water) are sent to the FCM. 6-PPD is injected at the inlet of the FCM at a content of 1.2 phr. At the outlet of the FCM, the mixture referred to as chunk leaves at 165° C. and with a content of volatile matter of between 1% and 3%. The Mooney viscosity measured for this composite (MS) is ≥200 and therefore cannot be measured by the machine (overtorque). Just at the outlet of the FCM, only half of the production (350 kg/h) is sent to the roll mill, the other half is discarded. At the outlet of the roll mill, the composite has a temperature of around 155° C., a Mooney viscosity of 150-170 on average and a content of volatile matter <1%, generally around 0.4%. This composite, at the outlet of the RM (Roll Mill), referred to as strip, is then sent to the end of the line.

Masterbatch M2A (In Accordance with the Invention):

At the outlet of the dewaterer, pellets having a throughput of 750 kg/h of dry product and loaded with 15% volatile matter (essentially water) are sent to the FCM. With this recipe, there is no injection of 6-PPD into the FCM. At the outlet of the FCM, the mixture referred to as chunk leaves at 165° C. and with a content of volatile matter of between 1% and 3%. The Mooney viscosity measured for this composite (MS) is >200 and therefore cannot be measured by the machine (overtorque). At the outlet of the FCM, the whole of the production (750 kg/h) is sent to the roll mill. At the outlet of the roll mill, the composite has a temperature of around 155° C., a Mooney viscosity of between 125 and 145 and a content of volatile matter <1%, generally around 0.4%. This composite, referred to as strip, is then sent to the prebreaker where it is mixed with 1.2 phr of 6-PPD. At the outlet of the prebreaker, the composite is sent to the end of the line.

Masterbatch M2B (In Accordance with the Invention):

At the outlet of the dewaterer, pellets having a throughput of 750 kg/h of dry product and loaded with 15% volatile matter (essentially water) are sent to the FCM. With this recipe, there is no injection of 6-PPD into the FCM. At the outlet of the FCM, the mixture referred to as chunk leaves at 165° C. and with a content of volatile matter of between 1% and 3%. The Mooney viscosity measured for this composite (MS) is >200 and therefore cannot be measured by the machine (overtorque). At the outlet of the FCM, the whole of the production (750 kg/h) is sent to the roll mill. At the outlet of the roll mill, the composite has a temperature of around 155° C., a Mooney viscosity of between 125 and 140 and a content of volatile matter <1%, generally around 0.4%. This composite, referred to as strip, is then sent directly to the end of the line. With this recipe, there is no injection of 6-PPD or other antioxidant into this masterbatch.

### IV-1.2 Preparation of the Rubber Compositions

The various compositions were produced from the masterbatch M1, M2A or M2B. The following tests are carried out in the following way: the masterbatch M1, M2A or M2B and the other components, except the vulcanization system, are introduced into an internal mixer which is 70% filled and the initial vessel temperature of which is approximately 60° C. Thermomechanical working (non-productive phase) is then performed in one step (total kneading time equal to about 5 min), until a maximum “dropping” temperature of about 165° C. is reached.

The mixture thus obtained is recovered, it is cooled and then the vulcanization system (sulfur and sulfenamide accelerator) is added on an external mixer at 70° C., everything being mixed (productive phase) for approximately 5 to 6 min. The compositions thus obtained are subsequently calendered, either in the form of slabs (thickness of 2 to 3 mm) or of thin sheets of rubber for the measurement of their physical or mechanical properties, or in the form of profiled elements which can be used directly, after cutting and/or assembling to the desired dimensions, for example as semi-finished products for tyres, in particular as tyre treads.

### IV-1.3 Mechanical Properties

The purpose of this example is to demonstrate that the properties of a rubber composition obtained with a masterbatch in accordance with the invention has the same mechanical properties as a masterbatch obtained by a conventional process.

Composition C1, not in accordance with the invention, is prepared from a masterbatch M1 according to the process described in detail in section IV-1.2, with 0.8 phr of antioxidant added.

Composition C2A, in accordance with the invention, is prepared from a masterbatch M2A according to the process described in detail in section IV-1.2, with 0.8 phr of antioxidant added.

Composition C2B, in accordance with the invention, is prepared from a masterbatch M2B according to the process described in detail in section IV-1.2. During this process, the antioxidant was introduced (2 phr).

All of the compositions have the following base formulation (in phr):

TABLE 1

| | C1; C2A; C2B |
|---|---|
| Natural rubber | 100 |
| Carbon black N234 | 72 |
| 6-PPD (1) | 2 |
| Stearic acid | 1.5 |
| ZnO (2) | 2.5 |
| Sulfur | 1.1 |
| CBS (3) | 1.1 |

(1) 6-PPD: N-(1,3-dimethylbutyl)-N′-phenyl-p-phenylenediamine: antioxidant
(2) ZnO: zinc oxide
(3) N-cyclohexyl-2-benzothiazolesulfenamide (Santocure CBS from the company Flexsys).

The properties measured after curine at 130° C. for 60 minutes are eiven in Table 2 below.

TABLE 2

| | C1 | C2A | C2B |
|---|---|---|---|
| MA300/MA100 | 1.5 | 1.6 | 1.6 |
| MFTR (k cycles) | 78.6 | 81.8 | 81.8 |
| G* (MPa) | 1.7 | 1.6 | 1.6 |
| Tan(δ)max | 0.22 | 0.21 | 0.21 |

The products C1 and C2A, C2B have the same mechanical properties.

### EXAMPLE 2

### IV.1.4 Preparation of a Masterbatch of Natural Rubber and Carbon Black

Coagulums of natural rubber (100 phr) and of carbon black (50 phr) having a very good dispersion value of the filler in the elastomer matrix are produced in the liquid phase according to the process described in U.S. Pat. No. 6,048,923.

They are then dried according to the following processes:

Masterbatch M3 (Not in Accordance with the Invention):

At the outlet of the dewaterer, pellets having a throughput of 1000 kg/h of dry product and loaded with 15% volatile matter (essentially water) are sent to the FCM. 6-PPD is injected at the inlet of the FCM at a content of 1.2 phr. At the outlet of the FCM, the mixture referred to as chunk leaves at 160° C. and with a content of volatile matter of between 1% and 3%. The Mooney viscosity measured for this composite (MS) is between 95 and 115. At the outlet of the FCM, the whole of the production (1000 kg/h) is sent to the roll mill. At the outlet of the roll mill, the composite has a temperature of around 155° C., a Mooney viscosity of 85-95 on average and a content of volatile matter <1%, generally around 0.4%. This composite, at the outlet of the RM, referred to as strip, is then sent to the end of the line.

Masterbatch M4A (In Accordance with the Invention):

At the outlet of the dewaterer, pellets having a throughput of 1000 kg/h of dry product and loaded with 15% volatile matter (essentially water) are sent to the FCM. With this recipe, there is no injection of 6-PPD into the FCM. At the outlet of the FCM, the mixture referred to as chunk leaves at 165° C. and with a content of volatile matter of between 1% and 3%. The Mooney viscosity measured for this composite (MS) is between 95 and 115. At the outlet of the FCM, the whole of the production (1000 kg/h) is sent to the roll mill. At the outlet of the roll mill, the composite has a temperature of around 155° C., a Mooney viscosity of between 55 and 65 and a content of volatile matter <1%, generally around 0.4%. This composite, referred to as strip, is then sent to the prebreaker where it is mixed with 1 phr of 6-PPD. At the outlet of the prebreaker, the composite is sent to the end of the line.

Masterbatch M4B (In Accordance with the Invention):

At the outlet of the dewaterer, pellets having a throughput of 1000 kg/h of dry product and loaded with 15% volatile matter (essentially water) are sent to the FCM. With this recipe, there is no injection of 6-PPD into the FCM. At the outlet of the FCM, the mixture referred to as chunk leaves at 165° C. and with a content of volatile matter of between 1% and 3%. The Mooney viscosity measured for this composite (MS) is between 95 and 115. At the outlet of the FCM, the whole of the production (1000 kg/h) is sent to the roll mill. At the outlet of the roll mill, the composite has a temperature of around 155° C., a Mooney viscosity of between 55 and 65 and a content of volatile matter <1%, generally around 0.4%. This composite, referred to as strip, is then sent directly to the end of the line. With this recipe, there is no injection of 6-PPD or other antioxidant into this masterbatch.

### IV-1.5 Preparation of the Rubber Compositions

The various compositions were produced from the masterbatch M3, M4A or M4B. The following tests are carried out in the following way: the masterbatch M3, M4A or M4B, and the other components except the vulcanization system, are introduced into an internal mixer which is 70% filled and the initial vessel temperature of which is approximately 60° C.

Thermomechanical working (non-productive phase) is then performed in one step (total kneading time equal to about 5 min), until a maximum “dropping” temperature of about 165° C. is reached. The mixture thus obtained is recovered, it is cooled and then the vulcanization system (sulfur and sulfenamide accelerator) is added on an external mixer at 70° C., everything being mixed (productive phase) for approximately 5 to 6 min.

The compositions thus obtained are subsequently calendered, either in the form of slabs (thickness of 2 to 3 mm) or of thin sheets of rubber, for the measurement of their physical or mechanical properties, or in the form of profiled elements which can be used directly, after cutting and/or assembling to the desired dimensions, for example as semi-finished products for tyres, in particular as tyre treads.

### IV-1.6 Mechanical Properties

The purpose of this example is to demonstrate that the properties of a rubber composition obtained with a masterbatch in accordance with the invention has the same mechanical properties as a masterbatch obtained by a conventional process.

Composition C3, not in accordance with the invention, is prepared from a masterbatch M3 according to the process described in detail in section IV-1.5, with 0.8 phr of antioxidant added.

Composition C4A, in accordance with the invention, is prepared from a masterbatch M4 according to the process described in detail in section IV-1.5, with 1 phr of antioxidant added.

Composition C4B, in accordance with the invention, is prepared from a masterbatch M4B according to the process described in detail in section IV-1.5. During this process, the antioxidant was introduced (2 phr).

All of the compositions have the following base formulation (in phr):

TABLE 3

| | |
|---|---|
| Natural rubber | 100 |
| Carbon black N234 | 50 |
| 6-PPD (1) | 2 |
| Stearic acid | 2.5 |
| ZnO (2) | 2.7 |
| Sulfur | 1.7 |
| CBS (3) | 0.75 |

(1) 6-PPD: N-(1,3-dimethylbutyl)-N′-phenyl-p-phenylenediamine: antioxidant
(2) ZnO: zinc oxide
(3) N-cyclohexyl-2-benzothiazolesulfenamide (Santocure CBS from the company Flexsys)

The properties measured after curing at 150° C. for 40 minutes are given in Table 4 below.

TABLE 4

| | C3 | C4A | C4B |
|---|---|---|---|
| MA300/MA100 | 1.48 | 1.53 | 1.53 |
| MFTR (k cycles) | 162 | 183 | 183 |
| G* (MPa) | 1.32 | 1.27 | 1.27 |
| Tan(δ)max | 0.12 | 0.12 | 0.12 |

The products C3 and C4A, C4B have the same mechanical properties.

By eliminating the injection of 6-PPD into the FCM (Farrel Continuous Mixer) upstream of the roll mill:

the Mooney viscosity of the composite is lowered,

the throughput is increased,

and this without degrading the properties of the composite as a mixture.

The fact of stopping the injection of 6-PPD into the FCM makes it possible to noticeably improve the cohesion of the composite on the roll mill, to rapidly lower its Mooney viscosity and to increase the production throughput (for the example of 72 phr of carbon black, the increase in the throughput is 100%; it is more than 30% for the example of 50 phr of carbon black.)

1. A process for preparing a masterbatch, comprising a diene elastomer and a reinforcing filler, and having a dispersion of the reinforcing filler in the elastomer matrix that has a Z value greater than or equal to 80, the diene elastomer comprises at least natural rubber, the process comprises the following successive steps:
a) introducing, in order to obtain a masterbatch in the form of dried mass, a coagulum into at least one heated continuous mixer, said coagulum comprises said diene elastomer and said reinforcing filler dispersed, with a Z value greater than or equal to 80, in the dried mass;
b) passing the mass leaving the continuous mixer into a roll mill in order to obtain a masterbatch in strip form; then
c) optionally, introducing the strip leaving the roll mill and an antioxidant into a continuous mixer so as to obtain a masterbatch comprising an antioxidant;
d) recovering, following step b) or c), said masterbatch having a moisture content of less than 1% by weight,
wherein the throughputs of steps a) and b) are greater than 500 kg/h,
and wherein when an antioxidant is present in the masterbatch obtained at the end of step d), the whole of said antioxidant is introduced during step c).

2. The process according to claim 1, wherein step c) is omitted and the masterbatch obtained at the end of step d) does not comprise antioxidant.

3. The process according to claim 1, wherein step c) is carried out, the masterbatch obtained at the end of step d) comprises an antioxidant and wherein the whole of said antioxidant is introduced during step c).

4. The process according to claim 3, wherein the antioxidant is an N-alkyl-N′-phenyl-para-phenyldiamine corresponding to the formula (I): 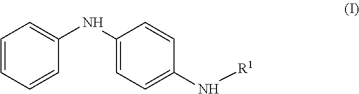
in which R¹ represents a linear or branched alkyl group having from 1 to 12 carbon atoms or a cycloalkyl group having from 5 to 8 carbon atoms.

5. The process according to claim 1, wherein the whole of the mass leaving the continuous mixer of step a) is sent to the roll mill of step b).

6. The process according to claim 1, wherein the throughputs of steps a) and b) are identical.

7. The process according to claim 1, wherein the masterbatch has a dispersion of the reinforcing filler in the elastomer matrix having a Z value greater than or equal to 90.

8. The process according to claim 1, wherein prior to step a) the coagulum is obtained by liquid-phase mixing starting from a latex of the diene elastomer and an aqueous dispersion of the reinforcing filler.

9. The process according to claim 8, wherein the coagulum is obtained according to the following steps:
feeding a continuous flow of the diene elastomer latex to a mixing region of a coagulation reactor defining an elongated coagulation region extending between the mixing region and an outlet,
feeding a continuous flow of a fluid comprising a reinforcing filler under pressure to the mixing region of a coagulation reactor in order to form a coagulated mixture,
dewatering the coagulum obtained previously in order to recover the dewatered coagulum of step a).

10. The process according to claim 1, wherein during step a) the continuous mixer is an FCM.

11. The process according to claim 1, wherein on leaving the continuous mixer of step a) the mass has a content of volatile matter of less than 5% by weight.

12. The process according to claim 1, wherein on leaving step b) the strip has a content of volatile matter of less than 1% by weight.

13. The process according to claim 1, wherein the reinforcing filler is a reinforcing organic filler.

14. The process according to claim 13, wherein the content of carbon black is between 40 and 90 phr.

15. The process according to claim 1, wherein the diene elastomer is a natural rubber.

16. A process for preparing a rubber composition comprising the following steps:
(A) preparing a masterbatch, comprising a diene elastomer and a reinforcing filler by the process according to claim 1;
(B) high-temperature thermomechanical kneading of the masterbatch obtained following step (A) with the other constituents of the rubber composition, except for the vulcanization system; and
(C) mechanical working, at a temperature below the temperature of step (B), of the product resulting from step (B) and incorporation of the vulcanization system.

17. The process according to claim 1, wherein the reinforcing filler is carbon black.

18. The process according to claim 17, wherein the content of carbon black is between 45 and 80 phr.
